(19) United States
(12) Patent Application Publication
(10) Pub. No.: US 2012/0014370 A1
(43) Pub. Date: Jan. 19, 2012

(54) EQUIPMENT, SYSTEM AND METHODOLOGIES FOR TIME SYNCHRONIZATION BETWEEN MULTIPLE RF FREQUENCIES, RF POWER, AND ANTENNA SELECTION OF BOOSTERS IN A SEGMENTED LISTENING AREA DELIVERING LOCALIZED AUXILIARY INFORMATION

(75) Inventors: Christopher F. DEVINE, Winnetka, IL (US); William R. HIEATT, Colleyville, TX (US); Richard J. BONICK, Evanston, IL (US)

(73) Assignee: LAZER SPOTS, LLC, Chicago, IL (US)

(21) Appl. No.: 13/245,482

(22) Filed: Sep. 26, 2011

Related U.S. Application Data
(63) Continuation-in-part of application No. 12/879,081, filed on Sep. 10, 2010.
(60) Provisional application No. 61/368,509, filed on Jul. 28, 2010.
(60) Provisional application No. 61/241,790, filed on Sep. 11, 2009.

(51) Int. Cl. H04W 4/06; H04W 4/00; H04B 7/212

(52) U.S. Cl. 370/347; 455/3.01

(57) ABSTRACT

Radio broadcasting equipment is provided that enables targeted radio broadcast advertisement delivery in an radio broadcast area wherein a plurality of radio auxiliary or booster transmitters are used to transmit localized auxiliary information to supplement broadcast area wide content transmitted on the same frequency. Moreover, these auxiliary or booster transmitters are configured to transmit different localized auxiliary information to supplement a plurality of main transmitters transmitted on corresponding specified transmission frequencies using Time Division Multiple Access frame structure.

### CROSS-REFERENCE TO RELATED APPLICATIONS

This United States Non-Provisional Patent application is a Continuation in Part application of U.S. patent application Ser. No. 12/879,081, filed Sep. 10, 2010, which relies for priority on U.S. Provisional Patent Application Ser. No. 61/241,790, filed on Sep. 11, 2009, entitled “Equipment, System And Methodologies For Segmentation Of Listening Area Into Sub-Areas Enabling Delivery Of Localized Auxiliary Information,” and U.S. Provisional Patent Application Ser. No. 61/368,509, filed Jul. 28, 2010 and entitled “Equipment, System And Methodologies For Segmentation Of Listening Area Into Sub-Areas Enabling Delivery Of Localized Auxiliary Information,” the disclosures of which are all being incorporated by reference in their entireties.

### FIELD OF THE INVENTION

Disclosed embodiments are directed, generally, to radio broadcasting equipment, as system and methodologies that enable targeted radio broadcast delivery in a radio broadcast area.

### BACKGROUND

Radio broadcasters obtain revenue by selling advertising commercial time, wherein the commercials, or “spots” are incorporated into the content broadcast by the radio broadcaster in broadcasting listening area. Typically, such broadcasters' listening areas are associated with a metropolitan area or geographic region and commercial time is sold to advertisers within that area or region.

However, the value of such commercial time is, in part, based on the number of listeners that are potentially hearing a commercial; nevertheless, the effectiveness of those commercials in persuading a listener to partake of an advertised product or service or visit an advertiser's location may be based, at least in part, on the availability of the advertiser's product, service or location to a listener. Thus, although a radio station listener may hear an advertiser's commercial, the likelihood that the listener may purchase the advertiser's product/service or visit the advertiser's location is at least in part based on the availability of advertiser's product/service or proximity of the advertiser's location.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

In accordance with at least one disclosed embodiment, radio broadcasting equipment is provided that enables targeted radio broadcast advertisement delivery in an radio broadcast area wherein a plurality of radio transmitters are used to transmit broadcasting area wide programming and localized auxiliary information on a single frequency and wherein broadcasting area wide programming is transmitted by at least one of the radio transmitters and localized auxiliary information is transmitted by individual radio transmitters included in the plurality of transmitters. In accordance with that disclosed embodiment, the equipment used to transmit localized auxiliary information for a particular frequency may be shared by broadcasters using a plurality of frequencies so as to reduce the cost of installation and operation of that equipment.

### BRIEF DESCRIPTION OF THE DRAWINGS

A more compete understanding of the present invention and the utility thereof may be acquired by referring to the following description in consideration of the accompanying drawings, in which like reference numbers indicate like features, and wherein:

FIG. 1 illustrates one example of a conventionally known radio broadcast listening area in which simulcasting technology may be used to provide effective broadcasting from a plurality of antennas on a single frequency.

FIG. 2 illustrates another example of a conventionally known radio broadcast listening area in which simulcasting technology may be used to provide effective broadcasting from a plurality of antennas on a single frequency.

FIG. 3 illustrates a radio broadcast listening area environment in which one or more of the illustrated embodiments may be utilized to deliver broadcast area wide programming as well as localized auxiliary information via a plurality of antennas on a single frequency.

FIG. 4 is an illustrative example of the interconnectedness and communication between a studio and various transmitters utilized in accordance with at least one embodiment 305-320.

FIG. 5 illustrates the equipment that may be used to implement, in whole or in part, the operations performed for the main transmitter in connection with any one of the disclosed embodiments.

FIG. 6 illustrates the equipment that may be used to implement, in whole or in part, the operations performed for one of the booster transmitter in connection with any one of the disclosed embodiments.

FIG. 7-9 illustrate the relative operation and cooperation of the main transmitter and the plurality of booster transmitters in accordance with at least the first, second and third illustrated embodiments.

FIG. 10 illustrates an example of a time slot configuration supporting booster transmitter sharing among multiple listening areas.

FIGS. 11(A)-11(E) illustrate one example of a booster transmitter configuration associated with the time slot sharing example shown in FIG. 10.

FIG. 12 illustrates one example of booster transmitters supporting transmission of localized auxiliary information associated with a particular zone within a listening area included in a service contour.

FIG. 13 illustrates a real world example of a service contour and an associated zone located within the service contour.

FIG. 14 illustrates the real world example of the service contour illustrated in FIG. 13 also illustrating the service contours associated with booster transmitters used within the service contour.

FIG. 15 illustrates an example of booster transmitters supporting transmission of localized auxiliary information associated with two different listening areas having differing service contours.

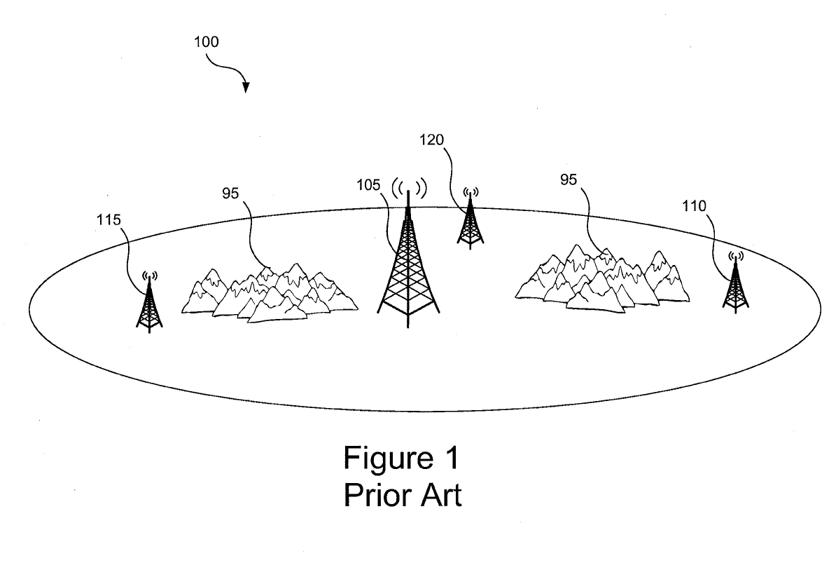

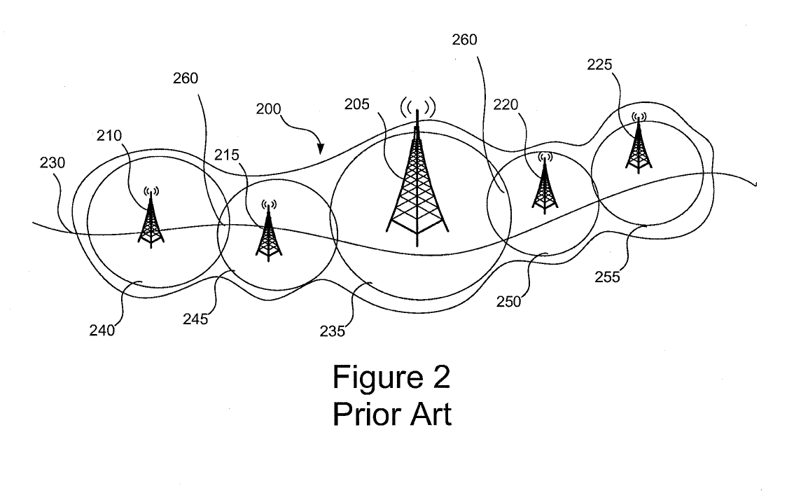

### DETAILED DESCRIPTION

The description of specific embodiments is not intended to be limiting of the present invention. To the contrary, those skilled in the art should appreciate that there are numerous variations and equivalents that may be employed without departing from the scope of the present invention. Those equivalents and variations are intended to be encompassed by the present invention.

In the following description of various embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope and spirit of the present invention.

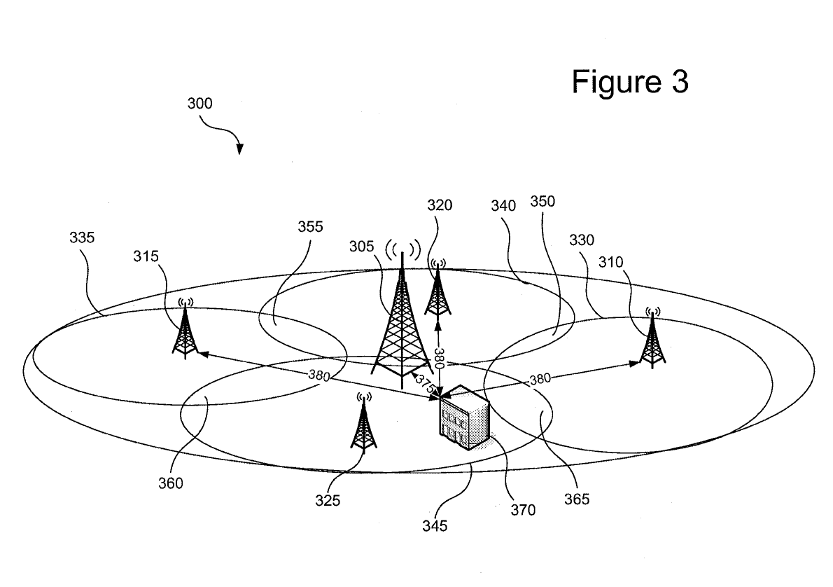

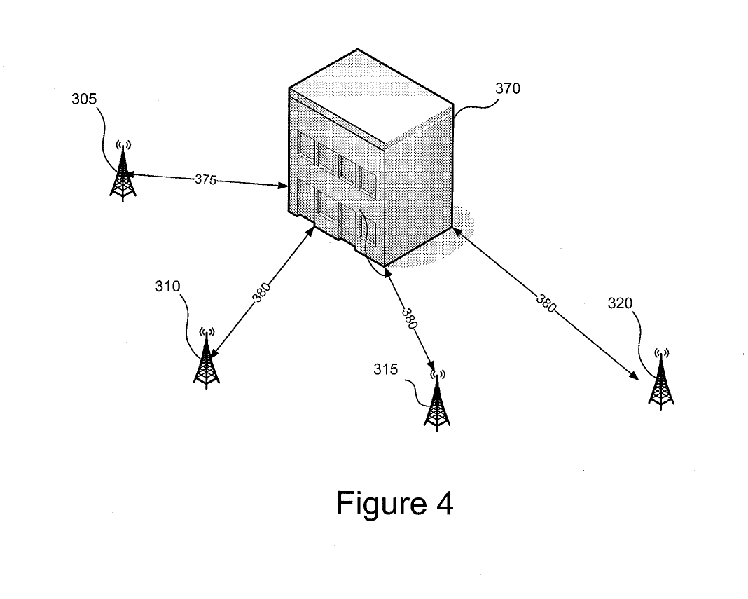

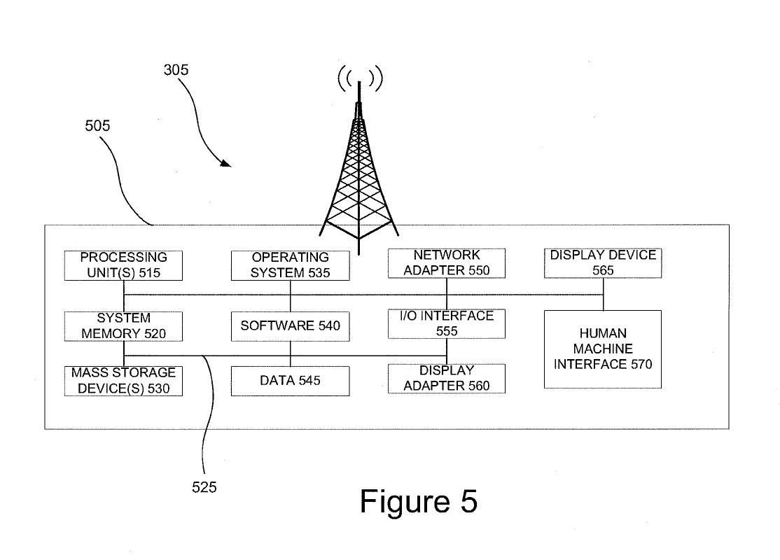

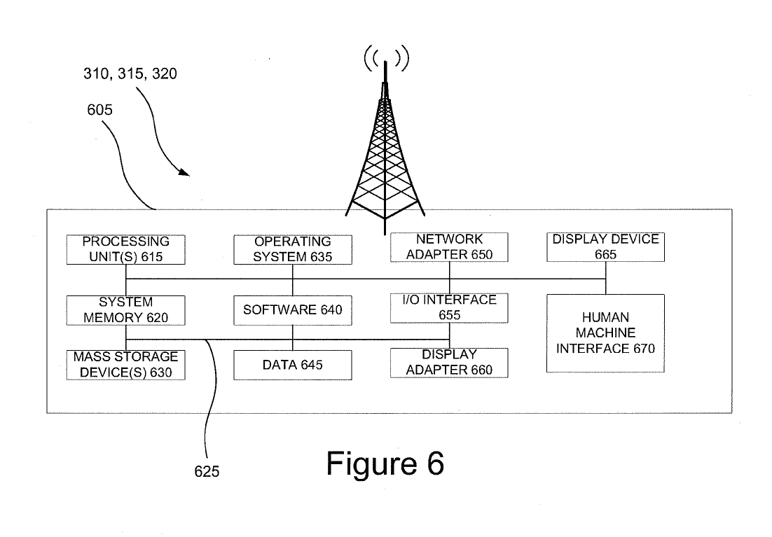

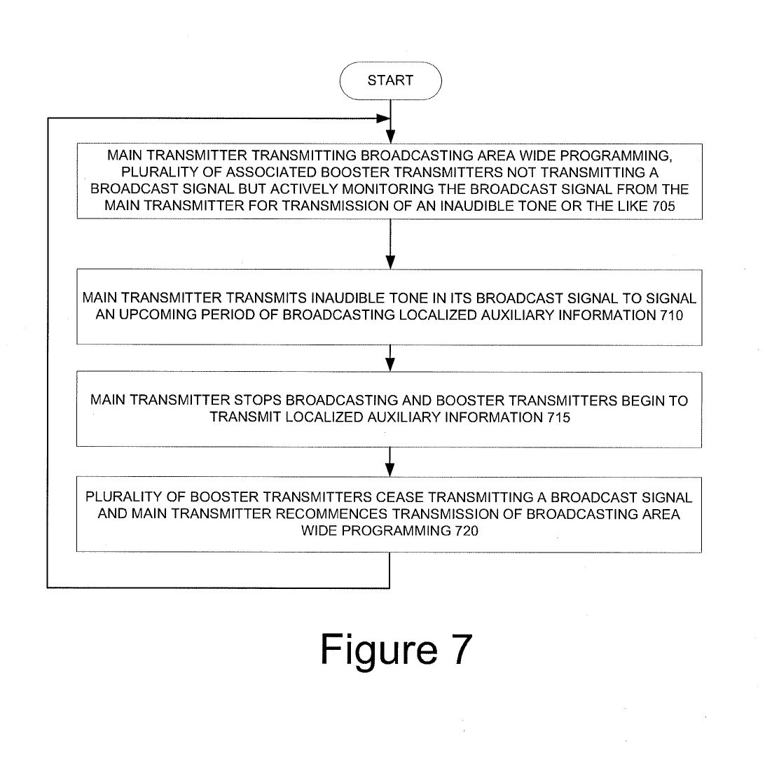

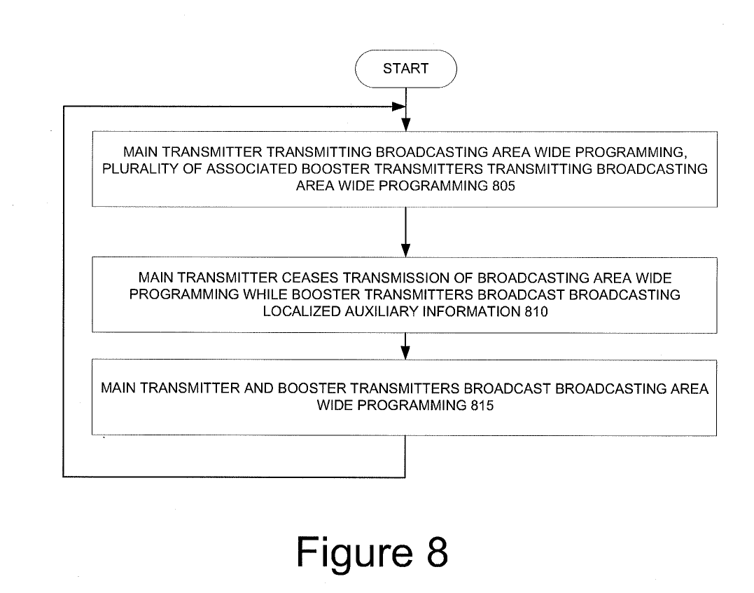

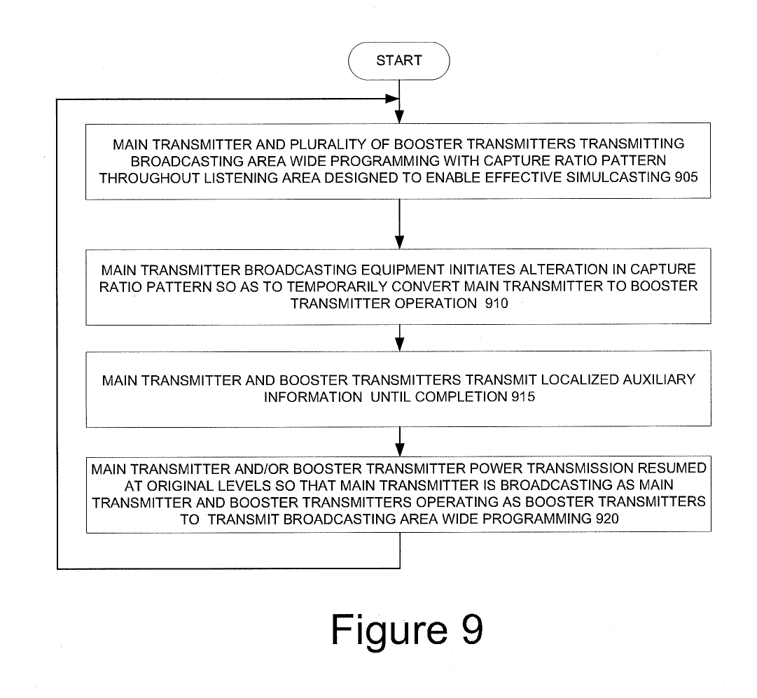

As explained above, U.S. patent application Ser. Nos. 12/879,081, 61/241,790, and 61/368,509 are expressly incorporated by reference herein. Detailed descriptions of FIGS. 3 1-9 have been omitted except where needed to supplement the present disclosure. A full discussion of FIGS. 3 1-9 can be found in the incorporated by reference material.

It should be understood that the term “radio broadcaster” is meant to include organizations and/or individuals involved in the broadcast of audio radio broadcasting area wide programming and localized auxiliary information. The term “broadcasting area wide programming” or “license coverage area” is meant to include, for example, programming content that is intended to be distributed throughout a particular broadcasting area; thus, depending on the format of the station, such programming may include, for example, talk radio programs, music programs, songs, etc. Likewise, the term “localized auxiliary information” is meant to include, e.g., advertisements, public safety information, public service information, emergency broadcast information, etc. Thus, radio broadcasters are not limited to individuals or organizations owning licenses for radio broadcasting; however, the term radio broadcaster does include such individuals or organizations.

In explaining the operation of various disclosed embodiments, description of one or more “main transmitters” and “booster transmitters” is provided. It should be understood that the term “main transmitter” encompasses a transmitter that may be, for example, the only transmitter used by a radio broadcaster in a particular radio broadcasting area or it may be the most powerful (or one of the most powerful) transmitters in the radio broadcasting area.

To the contrary, the term “booster transmitter” (which is interchangeable with the term “signal boosters”) includes low-power transmitters (relative to the maximum class of the main transmitter), which are conventionally used to improve communications in locations within the normal coverage area of a radio system where the radio signal is blocked or shielded due to natural terrain or man-made obstacles (e.g., to provide fill-in coverage but not increase the normal coverage area).

Booster transmitters can be effective in weak or no-signal areas that may be present in a radio broadcaster's area of operation; however, booster transmitters are designed so as not to extend the broadcast signal beyond a radio broadcaster's licensed broadcast area. Such booster transmitters can be used to compensate or accommodate for physical barriers to effective radio broadcast transmission, e.g., mountains, mountain ranges, steep valleys, large buildings, vegetation, etc.

As explained in U.S. patent application Ser. No. 12/879,081, a segmented listening area that is configured to deliver localized auxiliary information may utilize “zones” within the FCC defined service area of a FM broadcast transmitter associated with a particular broadcaster. These zones may contain 1 to N number of on-channel, same frequency boosters that broadcast, in a simulcast manner, during specific instances in time.

In accordance with at least one implementation of the disclosed embodiments of U.S. Ser. No. 12/879,081, the design of the zone may be such that the signal power from the on-channel boosters in the zone may radiate a signal significantly stronger than the broadcaster's main station transmitter in the zone. Therefore, FM receivers in the zone capture on the on-channel booster signal rather than the main transmitter signal. Thus, a broadcaster can transmit different, local audio information to the specific zone. At the same time, there may exist several other on-channel zones within the listening area that are simultaneously, or independently, broadcasting different information that the broadcaster wants to transmit in that particular zone. These zones may be separated geographically so as not to emit transmission signals that interfere with each other.

In accordance with the presently disclosed embodiments, it has been recognized that inefficiencies may exist because the zones of a particular broadcaster's listening area may be broadcasting independent information for only a short period of the total broadcast time during a given time period. For example, the independent zones may only broadcast zone-specific information (also referred to in U.S. patent application Ser. No. 12/879,081 as localized auxiliary content) only for several minutes out of an hour, depending on how much zone-specific information the broadcaster wants to transmit. Accordingly, in order to improve efficiency, in accordance with a now disclosed embodiment, the zone-specific booster transmitters may be controlled to transmit signals more often.

One implementation to accomplish this improved efficiency involves broadcast of zone-specific information by the booster transmitters on more than one RF frequency. As a result, a particular booster transmitter may be shared by more than one broadcaster and, therefore, may be used to support the localized content subdivision of a listening area by more than one broadcaster using their particular FM broadcasting frequencies.

In accordance with at least one disclosed embodiment, localized auxiliary content may be transmitted from the booster transmitter(s) in a Time Division Multiplex (TDMA) frame structure such that the information to be broadcast on each frequency does not overlap in time. As a result, the booster transmitter(s) can transmit on multiple RF frequencies separated by time, and provide localized auxiliary content transmission on different transmission frequencies within the particular zone(s) of more than one radio broadcaster.

Accordingly, multiple radio broadcasters with different RF frequencies can utilize the zone boosters to transmit localized auxiliary content. Thus, multiple broadcasters respectively transmitting on multiple broadcast frequencies may transmit on all or only a subset of the booster transmitters in a particular zone for their respective zone transmissions; the selection of which boosters to utilize for transmission of localized auxiliary content may be determined by geographical or regulatory requirements. Additionally, the RF power and the selection of a RF antenna may vary for each RF frequency that is transmitted, to obtain optimal performance and meet regulatory requirements.

It should be understood that each zone pertains to a particular area within a listening area but may extend beyond a single booster transmission area.

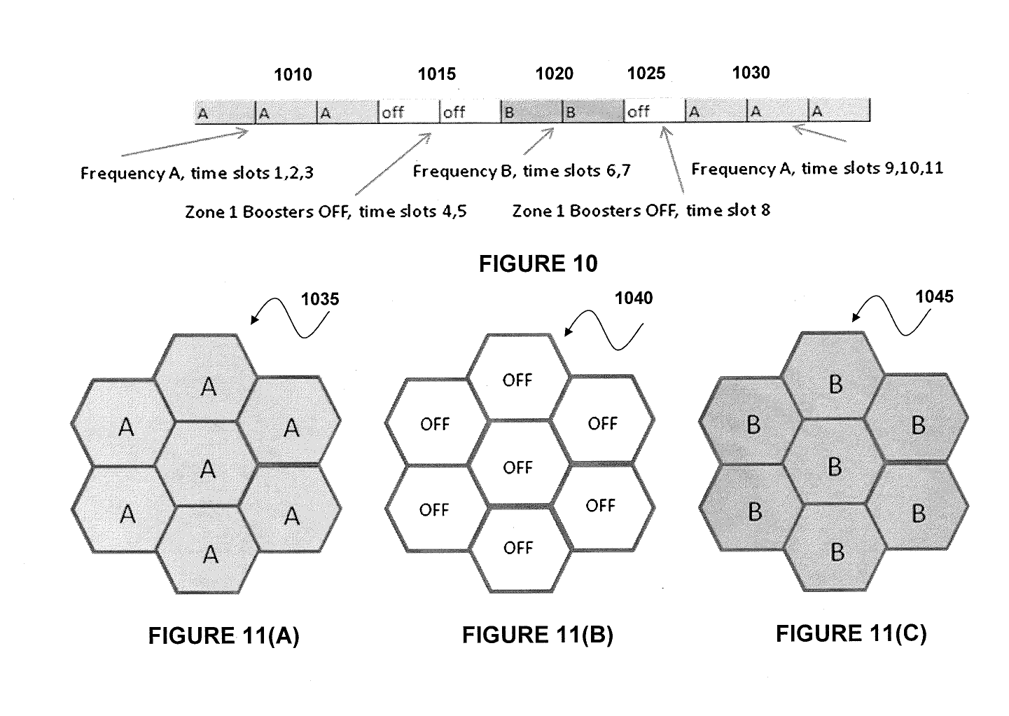

FIG. 10 illustrates a time and frequency perspective for one potential example of how system equipment might be utilized to provide for time synchronization between multiple RF frequencies, RF power, and antenna selection of boosters in a segmented listening area delivering localized auxiliary information. More specifically, FIG. 10 shows an exemplary booster sample time sequence for a first zone (ZONE 1) within a multi-zone listening area. The typical duration for the time slots may be 15 to 30 seconds. As shown in FIG. 10, the zone's transmitter(s) are transmitting on frequency A during time slots 1-3 (transmission period on frequency A 1010), on frequency B during time slots 6-7 (transmission period on frequency B 1020) and again on frequency A during time slots 9-11 (transmission period on frequency A 1030). During time slots 4-5 and 8, no transmission is made because the booster transmitter(s) are shut off (periods 1015 and 1025).

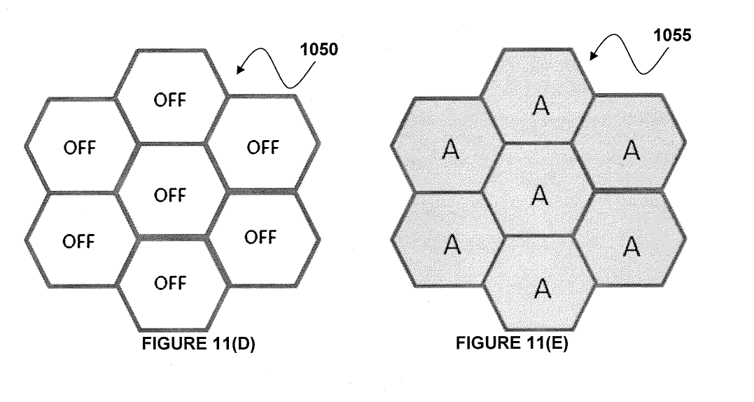

As shown in corresponding FIGS. 11(A)-(E), each hexagon represents a single booster transmitter within the Zone 1 1000; the transmission sequence that would appear for a 7 booster transmitter zone would be as shown in FIGS. 11(A)-11(E), which corresponds to the transmission periods associated with frequencies A and B and the intermittent shutting off of transmissions from the boosters there between. More specifically, as shown in FIG. 11(A), the boosters of Zone 1 would be transmitting on frequency A during the time period including time slots 1-3. Subsequently, as shown in FIG. 11(B), the boosters of Zone 1 would cease transmission in the time period including the time slots 4-5. Subsequently, as shown in FIG. 11(C), the boosters of Zone 1 would be transmitting on frequency B during the time period including time slots 6-7. Subsequently, as shown in FIG. 11(D), the boosters of Zone 1 would cease transmission in the time period including the time slot 8. However, as shown in FIG. 11(E), the boosters of zone 1 would be again transmitting on frequency A during the time period including time slots 9-11.

In field deployment of these zones of a listening area or listening areas, a service contour of the main transmitter associated with a listening area cannot be extended by the operation of booster transmitters under current FCC rules. As a result, the service contour of any booster transmitter to be used in conjunction with a main transmitter (and which is at the same field strength level of that main transmitter) would be required by the FCC to be positioned within that main transmitter's service contour.

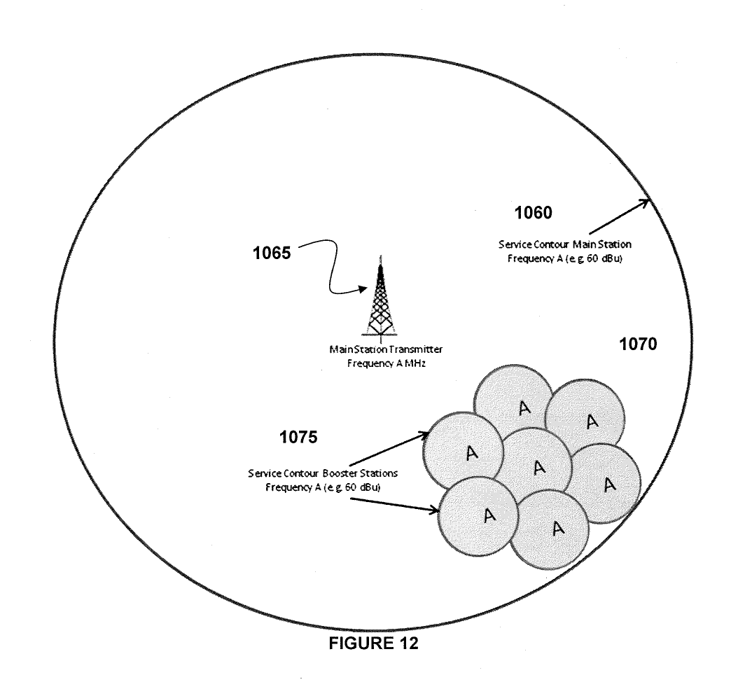

Thus, as illustrated in FIG. 12, a listening area's service contour 1060 for a main station transmitter frequency A (e.g., 50 dBu) 1065 would be included within the listening area 1070 encompassed by the service contour 1060 Likewise, the at least one service contour booster stations A (i.e., booster transmitters) 1075 would be operating at the same transmission frequency (e.g., 60 dBu) and would likewise be within the listening area 1070.

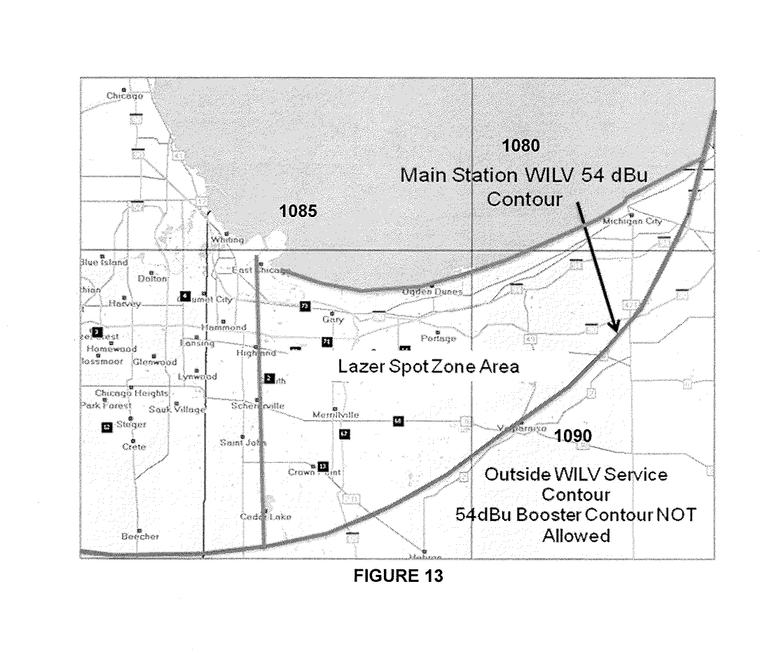

Accordingly, as illustrated in FIG. 13 a main transmitter operating at a frequency A, would have a service contour 1080 that would delineate between the listening area 1085 and the outside the service contour. Thus, outside the WILV (the station in question) service contour 1080, there are no boosters allowed in area 1090. Accordingly, booster stations can only be positioned and configured to transmit within the service contour of the associated listening area 1085. Accordingly, the booster transmitter service contours that are also on Frequency A are would need to be within the main transmitter A contour 1080 to be in compliance with FCC requirements.

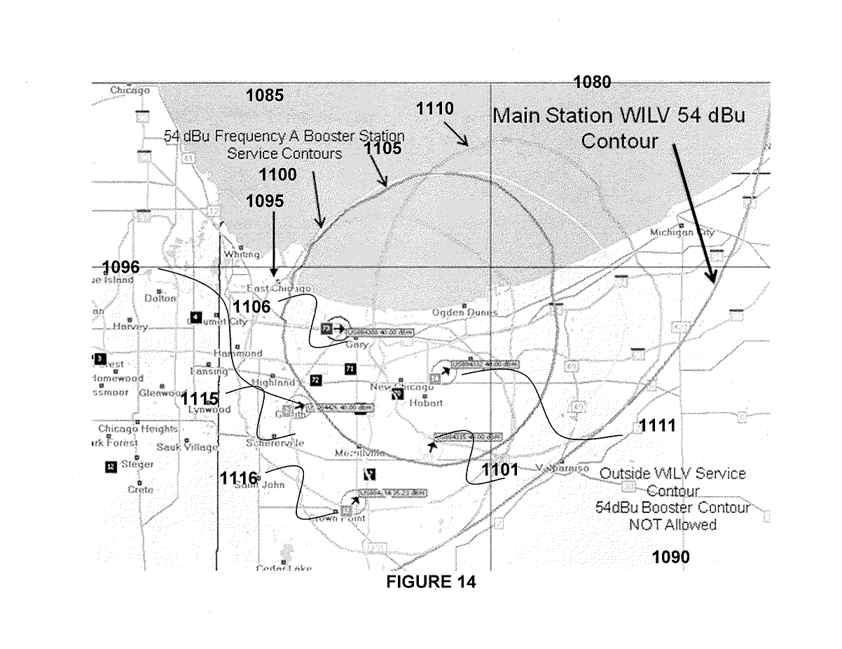

FIG. 14 illustrates another example for a particular radio station, WILV in Chicago, Ill. As shown in FIG. 14, the main transmitter service contour 1010 again demarcates between the listening area 1085 and the area outside the listening area 1090. Included within the service contour 1080 are the service contours 1095, 1100, 1105, 1110 and 1115 corresponding to four incorporated booster transmitters 1096, 1101, 1106, 1111, and 1116.

In order to make the booster transmitters more efficient, i.e. to transmit in more timeslots, the booster transmitters 1095-1115 can be configured or controlled to switch to Frequency B MHz when they are not transmitting on Frequency A MHz, as previously discussed. For example, if the main transmitter A's service contour is the same as a service contour for a main transmitter B associated with another or the same broadcaster within the same geographical region, then the booster transmitters may be used by the broadcaster for main transmitter B to broadcast auxiliary content in the same way as main transmitter A does. It should be understood that the booster transmitters would be configured to transmit different auxiliary content at different times depending on whether they were supporting transmission by main transmitter A or main transmitter B. Accordingly, the use of a timeslot based transmission scheme has particular utility for booster-sharing.

Using this booster-sharing technique, booster transmitters could simply change frequency and transmit at the same Effective Radiated power (ERP) during the B timeslots, again in a simulcast mode.

If a broadcaster has a radio station with a listening area (associated with a main transmitter B) that is different than the listening area associated with main transmitter A, then the operation of the booster transmitters would need to take into account the difference in the service contours between that associated with main transmitter A and that associated with main transmitter B.

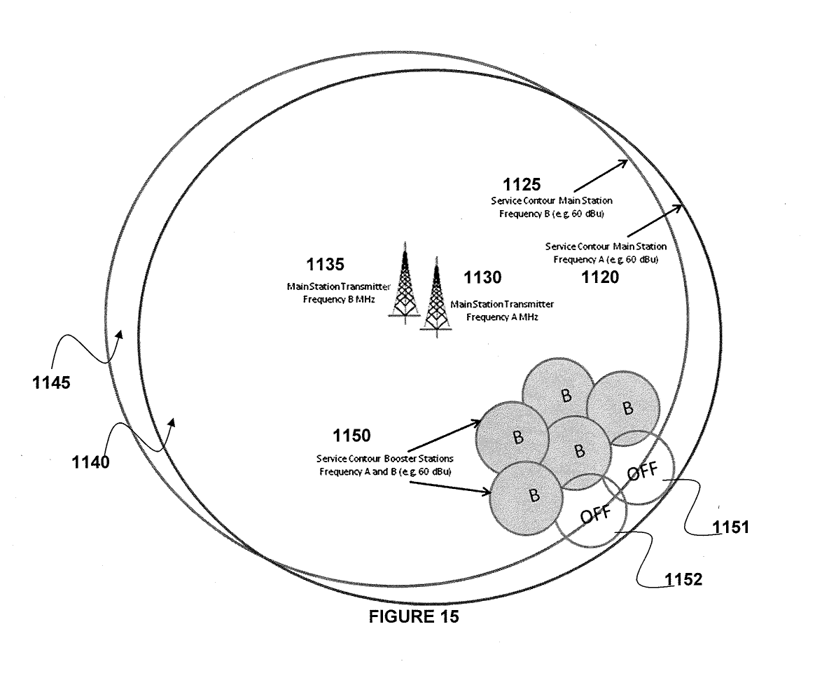

Thus, as shown in FIG. 15, a first service contour A 1120 would be associated with main transmitter A 1130 where a second service contour B 1125 would be associated with a main transmitter B 1135. As a result the first service contour A 1120 would correspond to a service area 1140 while the second service contour B 1125 would correspond to the service area 1145. As a result, a portion of the booster stations 1150 that operate to support transmission of localized auxiliary content for main transmitter A 1130 would not be permitted to be operated to support main transmitter B 1135. This is because main transmitter B's service contour would not fully encompass the service contours 1151, 1152 associated with those booster transmitters. This could be done by a physical switch of transmitter output power to another antenna, or through the use of ‘smart antenna’ technology as is common in cellular and broadband (e.g. WiMAX) applications.

Alternatively, or in addition, the booster transmitter(s) 1151, 1152 could switch RF radiating antennas dynamically to optimize the coverage and control the radiated power such that it does not violate FCC regulatory requirements.

Any number of booster transmitters with any number of frequency combinations could be deployed in this manner, limited to the total time that is available for support of a particular main transmitter or associated service area.

It should also be appreciated that a plurality of zones could exist within a service contour that could behave in the same manner, but independent of the other zones and separated geographically as to not interfere with one another.

It should also be appreciated that, in accordance with at least one disclosed embodiment, at any particular time, a booster transmitter may be transmitting on any particular frequency, but only one at a time. However, alternatively, the embodiments may be implemented using one or more linear FM transmitters that can configured to transmit on multiple frequencies at the same time. As one option for implementation, a plurality of booster transmitters may be located at the same site and a combiner(s) may be used to support transmission of localized content, e.g., localized traffic reports

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

For example, it should be understood that various disclosed embodiments relate to the broadcasting of analog radio broadcasting signals. However, it should be understood that the embodiments are not limited to analog radio broadcasting and may by utilized in digital audio radio broadcasting, for example, Eureka 147 (also known as Digital Audio Broadcasting (DAB)), ‘DAB+, FM band in-band on-channel (FM IBOC) broadcasting including HD Radio (OFDM modulation over FM and AM band IBOC sidebands) and FMeXtra (FM band IBOC subcarriers), Digital Radio Mondiale (DRM) and its extension (DRM+) (OFDM modulation over AM band IBOC sidebands), AM band in-band on-channel (AM IBOC) including HD Radio (AM IBOC sideband) and DRM, Satellite radio including, e.g., WorldSpace, Sirius XM radio, and MobaHo!, Integrated Services Digital Broadcasting (ISDB), Low-bandwidth digital data broadcasting over existing FM radio and Radio Data System (also known as RDS), etc.

It should be appreciated that, in accordance with at least one embodiment of the invention, the system may be implemented in conjunction with the transmission of digital radio signals rather than analog radio signals. Moreover, it should be appreciated that at least one embodiment of the invention may be implemented in conjunction, and be compatible, with the DAB standard to enable implementation outside the United States radio markets.

Further, it should be appreciated that the various disclosed embodiments and their individual aspects and features also may be utilized in the transmission of analog and/or digital television signals.

Moreover, it should be understood that various connections are set forth between elements in the following description; however, these connections in general, and, unless otherwise specified, may be either direct or indirect, either permanent or transitory, and either dedicated or shared, and that this specification is not intended to be limiting in this respect.

Additionally, it should be understood that the functionality described in connection with various described components of various invention embodiments may be combined or separated from one another in such a way that the architecture of the invention is somewhat different than what is expressly disclosed herein. Moreover, it should be understood that, unless otherwise specified, there is no essential requirement that methodology operations be performed in the illustrated order; therefore, one of ordinary skill in the art would recognize that some operations may be performed in one or more alternative order and/or simultaneously.

Various components of the invention may be provided in alternative combinations operated by, under the control of or on the behalf of various different entities or individuals.

Further, it should be understood that, in accordance with at least one embodiment of the invention, system components may be implemented together or separately and there may be one or more of any or all of the disclosed system components. Further, system components may be either dedicated systems or such functionality may be implemented as virtual systems implemented on general purpose equipment via software implementations.

Unless otherwise expressly stated, it is in no way intended that any operations set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following inventive concepts.

Although the utility of various invention embodiments has been described in connection with the distribution of promotional content, it should be understood that distributed information is not limited to promotional content but may also or alternatively include non-promotional material.

Thus, for example, in accordance with at least one embodiment of the invention, an optional emergency services announcement component may be included. Such a component may be implemented, for example, to be responsive to a wirelessly communicated notification transmitted via a wireless transmitter under the control of emergency services personnel. Thus, in the event that an emergency announcement is required, fire, police or other emergency services department personnel may interrupt a regular broadcasting to trigger broadcasting in one or more (or all) subsets of a broadcasting area to provide emergency information regarding, a forest fire, a tornado warning, flash flood warnings, etc. Accordingly, the wirelessly communicated notification may include pre-recorded information to be transmitted on the one or more boosters and/or simply enable a trigger within the system to shift an audio source for a booster to a channel associated with emergency broadcast information.

Likewise, it should be appreciated that emergency services personnel could utilize this type of wireless communicated microcast notification for implementing an Amber Alert type announcement to disseminate information associated with child-abduction situations.

In accordance with at least one embodiment of the invention, the boosters may also be used as a transmission location point for communicating text messages or the like to a user's mobile phone or other Personal Data Assistant (PDA) based on the geographic location of the user. Accordingly, when a user travels into the booster area, the user's device may receive promotional information or offers regarding that an advertiser's business in that area. It should be appreciated that the transmission of such data from the boosters may be using a different communication protocol and technology and may not have any relationship to the timing of shifting from transmission of content from a main transmitter to one or more booster transmitters or vice versa.

In accordance with at least one embodiment of the invention, the booster transmitters, for example, may be configured to transmit a signal that may be received by circuitry installed at one or more billboards or other signage within a localized area associated with the booster. The transmission and receipt of the signal would trigger an LED readout on the board which would become visible simultaneously with the broadcasting of promotional material via the booster.

As a result, it will be apparent for those skilled in the art that the illustrative embodiments described are only examples and that various modifications can be made within the scope of the invention

We claim:

1. Radio broadcasting equipment comprising:
a plurality of auxiliary transmitters associated with at least two main transmitters, the at least two main transmitters transmitting broadcast area wide programming for their respective broadcast areas; and
a mechanism for switching on transmission of localized auxiliary information content by at least one of the plurality of auxiliary transmitters, wherein the at least one of the plurality of auxiliary transmitters transmits localized auxiliary information content on at least one of the transmission frequencies of the two main transmitters.

2. The radio broadcasting equipment of claim 1, wherein the mechanism for switching on transmission of localized auxiliary information content by at least one of the plurality of auxiliary transmitters also reduces a power level of transmission by the corresponding main transmitter having the frequency upon which the at least one auxiliary transmitter is transmitting localized auxiliary information content,

3. The radio broadcasting equipment of claim 1, wherein the broadcast area wide programming content includes programming content for distribution throughout a particular broadcasting area associated with one of the at least two main transmitters and the localized auxiliary information content includes at least one of advertisements, public safety information, public service information, emergency broadcast information.

4. The radio broadcasting equipment of claim 1, further comprising at least one Studio-Transmitter Link coupled to each of the plurality of transmitters and configured to carry both broadcast area wide programming and auxiliary information content transmitted from one or more studios to the plurality of transmitters.

5. The radio broadcasting equipment of claim 1, wherein the mechanism for switching on transmission of localized auxiliary information content is further configured to transmit localized auxiliary information content at a specified transmission frequency on a subset of the plurality of auxiliary transmitters having service contours that are within a service contour of a main transmitter operating at that specified transmission frequency and included in the at least two main transmitters.

6. The radio broadcasting equipment of claim 1, wherein the plurality of transmitters transmit analog radio signals

7. The radio broadcasting equipment of claim 1, wherein the plurality of transmitters transmit digital radio signals.

8. The radio broadcasting equipment of claim 1, wherein each of the auxiliary transmitters is configured to transmit localized auxiliary information content when the main transmitter has ceased transmission of broadcast area wide programming content.

9. The radio broadcasting equipment of claim 1, wherein each of the auxiliary transmitters is configured to transmit different localized auxiliary information content associated with the at least two main transmitters using Time Division Multiple Access frame structure to transmit localized auxiliary information content for different main transmitters in different time slots.

10. The radio broadcasting equipment of claim 1, wherein the plurality of auxiliary transmitters are located in a zone of the broadcast area of at least one of the main transmitters included in the at least two main transmitters.

11. The radio broadcasting equipment of claim 10, wherein the zone is one of a plurality of zones included in the broadcast area of the at least one of the main transmitters.

12. The radio broadcasting equipment of claim 1, wherein localized auxiliary information content includes audio data spoken in a language other than the language of the broadcast area wide programming content.

13. The radio broadcasting equipment of claim 1, wherein the mechanism includes components for incorporating an inaudible tone in the signal broadcast by the main transmitter, which triggers the auxiliary transmitters to begin transmission of localized auxiliary information in a specified period of time

14. The radio broadcasting equipment of claim 1, wherein the mechanism includes at least one dedicated communication link provided between the main transmitter and each of the plurality of auxiliary transmitters and configured to carry control information indicating when transmission of localized auxiliary information by each of the plurality of auxiliary transmitters should begin.

15. The radio broadcasting equipment of claim 1, wherein localized auxiliary information content is transmitted to at least some of the plurality of auxiliary transmitters based on identification of the frequency upon which that localized auxiliary information content is to be transmitted.

16. A method to transmitting both broadcast area wide programming content and localized auxiliary information content within a single broadcast area, the method comprising:
operating a plurality of transmitters including a main transmitter and a plurality of auxiliary transmitters; and
triggering transmission of localized auxiliary information content by at least one of the plurality of auxiliary transmitters, wherein the at least one of the plurality of auxiliary transmitters transmits localized auxiliary information content on at least one of the transmission frequencies of the two main transmitters.

17. The method of claim 16, a power level of transmission by the main transmitter having the transmission frequency at which the at least auxiliary transmitter is transmitted is reduced during transmission of localized auxiliary information by that at least one auxiliary transmitter.

18. The method of claim 16, wherein the broadcast area wide programming content includes programming content for distribution throughout a particular broadcasting area and the localized auxiliary information content include at least one of advertisements, public safety information, public service information, emergency broadcast information.

19. The method of claim 16, further comprising coupling each of the plurality of transmitters to one or more studios via at least one communication link and transmitting at least one of broadcast area wide programming and auxiliary information content from the one or more studios to at least one of the plurality of transmitters.

20. The method of claim 16, wherein each of the auxiliary transmitters is configured to transmit localized auxiliary information content at a specified transmission frequency when a main transmitter having the same specified transmission frequency and included in the at least two main transmitters has ceased transmission of broadcast area wide programming content.
